(19) United States
(12) Patent Application Publication
(10) Pub. No.: US 2009/0231682 A1
(43) Pub. Date: Sep. 17, 2009

(54) HIGH-POWER FIBER AMPLIFIER

(75) Inventors: Raman Kashyap, Baie d'Urfe (CA); Galina Nemova, Dollard-des-Ormeaux (CA)

Correspondence Address: CHOATE, HALL & STEWART LLP, TWO INTERNATIONAL PLACE, BOSTON, MA, 02110, US

(73) Assignee: CORPORATION DE L'ECOLE POLYTECHNIQUE DE MONTREAL, Montreal (CA)

(21) Appl. No.: 12/355,951

(22) Filed: Jan. 19, 2009

Related U.S. Application Data
(60) Provisional application No. 61/021,733, filed on Jan. 17, 2008.

(51) Int. Cl. H01S 3/00

(52) U.S. Cl. 359/341.1

(57) ABSTRACT

Fiber light amplifiers adapted for high power application are provided. In embodiments of the invention, the light signal to be amplified is coupled to a cladding mode of an active waveguide region which is cladding doped. The amplified light is coupled to an output fiber have waveguiding properties matching those of the active cladding of the active waveguide region. In other embodiments, two or more amplifying stages are provided coupled by a wavelength selective loss element which couples the Stokes wave co-propagating with the signal to be amplified out of the signal guiding mode prior to the onset of SRS.

### FIELD OF THE INVENTION

The present invention relates to the field of optical devices and more particularly concerns high power fiber amplifiers.

### BACKGROUND OF THE INVENTION

High-power amplifiers, for example in the relatively eye-safe wavelength range 1.5-1.6 μm, are of great interest for scientific and engineering applications, such as laser cutting and machining. Their compatibility with telecommunications components provides the possibility to use lower-cost and widely available devices. An Er³⁺ doped fiber is the best choice in this wavelength range. The high Er³⁺ concentration which is required for efficient operation of an erbium-doped fiber amplifier (EDFA) and permits the use of shorter fibers to increase threshold powers for unwanted nonlinear effects such as stimulated Raman scattering (SRS) and stimulated Brillouin scattering (SBS), results in an increase in a refractive index relative to pure silica. Fiber amplifiers doped with other rare-earth elements are also of interest.

Current high power fiber amplifiers are nearly always realized with rare-earth-doped double-clad fibers, which are pumped with fiber-coupled high power diode bars or other kinds of laser diodes. The pump light is launched into an inner cladding rather than into the (much smaller) fiber core in which amplification takes place. The output signal can have a very good, even diffraction-limited beam quality if the fiber has a single-mode core. For the highest powers, one requires a rather large core area (large mode area fibers), because the optical intensities otherwise become too high and nonlinear effects become unavoidable.

Unwanted nonlinear effects include Stimulated Brillouin Scattering (SBS) and Stimulated Raman Scattering (SRS). Both Brillouin and Raman type scattering refer to the inelastic scattering of a photon which results in a photon of longer wavelength called the Stokes wave and a phonon, the phonon being optical in the Raman case and acoustical in the Brillouin case. When the optical intensity in the fiber rises above a corresponding threshold, a stimulated regime is reached where the Stokes wave is amplified, significantly depleting the optical energy from the signal being amplified and creating unacceptable noise.

International patent application WO2008/097986 (RAMACHANDRAN et al) teaches a high power amplification scheme where the input signal is converted to a high order mode (HOM) in order to match the pump profile, thereby improving energy extraction. The resulting numerical aperture of the waveguide is larger which increases the threshold for the onset of non-linear effects. The propagation of the signal in a high order mode however complicates its coupling at the output of the amplifier, necessitating the use of external components such as a phase plate as shown in FIGS. 1A and 1B of Ramachandran.

SAHU et al (PHOTONICS-2008: International Conference on Fiber Optics and Photonics, Dec. 13-17, 2008, IIT Delhi, India) reviews the progress of rare-earth doped fiber technology towards power scaling of high-brightness fiber sources. The necessity for large core size and Numerical Aperture (NA), as well as proper control of the modal shape of the signal guiding mode is discussed. The use of complex refractive index shapes to design the fiber to selectively guide the amplified signal while creating a lossy medium for other wavelengths is also presented. The proper control of the optical fiber fabrication process to obtain such complex profile is however very difficult to achieve, as commented on by SAHU et al.

There remains a need for a high power fiber amplifier which alleviates at least some of the drawbacks of the prior art.

### SUMMARY OF THE INVENTION

In accordance with a first aspect of the invention, there is provided a light amplifier which includes:
an input optical fiber supporting an input mode;
an active waveguide region optically coupled to the input optical fiber and having a core and a first cladding. The first cladding is rare-earth doped and pumped to define an amplification medium. The active waveguide region supports at least one cladding mode;
an input grating for coupling light from the input mode to one of the at least one cladding mode of the active waveguide region; and
an output optical fiber optically coupled to the active waveguide region. The output optical fiber has a core having waveguiding properties substantially matching waveguiding properties of the first cladding of the active waveguide region.

In accordance with another aspect of the invention, there is also provided a light amplifier for amplifying an input light signal which includes:
first and second amplification stages successively amplifying the input light signal. Each amplification stage includes an optical fiber segment supporting a signal guiding mode for guiding the input light signal, the optical fiber segment being doped and pumped to define an amplification medium amplifying the input light signal. The optical fiber segment generates a Stokes wave through Raman scattering of the input light signal, the Stokes wave co-propagating with the input light signal in the signal guiding mode; and
a wavelength selective loss element provided between the first and second amplification stages for selectively coupling the Stokes wave generated in the optical fiber segment of the first amplification stage out of the signal guiding mode.

Other features and advantages of the present invention will be better understood upon reading of preferred embodiments thereof with reference to the appended drawings.

### BRIEF DESCRIPTION OF THE DRAWINGS

FIGS. 1A and 1B are schematic cross-sectional representations of fiber amplifiers according to embodiments of the invention.

FIG. 2 is a graph showing the dependence of the Stimulated Brillouin Scattering threshold on the signal bandwidth.

FIG. 3 is a graph showing the dependence of the Stimulated Raman Scattering threshold on the length of the fiber (L) for a signal (λₛ=1.531 μm) and for the pump (λₚ=1.48 μm) wavelengths.

FIG. 4 is a graph respectively showing the forward (dashed line) and backward (solid line) traveling ASE in an amplifier according to an embodiment of the invention.

FIGS. 5A to 5C a schematic representations of light amplifiers incorporating a wavelength selective loss element according to embodiments of the invention.

FIG. 6 is a graph illustrating the effect of a wavelength selective loss element on the growth of Stokes wave.

FIG. 7A is a schematic representation of an optical sensor using a wavelength selective loss element. FIG. 7B is a schematic representation of a an optical sensor including a plurality of sensing fiber sections.

### DETAILED DESCRIPTION OF EMBODIMENTS OF THE INVENTION

Embodiments of the present invention provide high-power amplifiers which avoid or minimize the onset of non-linear effects while still allowing for a relative ease of construction and design.

Light amplifiers according to such embodiments may be used to increase the power of any appropriate light signal, depending of the intended application of the device. The terms “light” or “optical” are used herein to refer to any appropriate portion of the electromagnetic spectrum. The light signal to be amplified may have various spectral, temporal or intensity characteristics, as dictated by its intended use. As mentioned above, the wavelength range 1.5-1.6 μm is for example of particular interest for applications such as laser cutting and machining, and in view of the compatibility of wavelengths within that range with existing telecommunications components. It will however be understood that the amplifiers of the present invention are not limited to such a context and may be adapted to other applications requiring high-power amplification. It will be further understood that the expression “signal” is meant to designate in general the light beam of interest amplified by the devices of the present invention and is not meant to be limited to light beams in which information has been encoded.

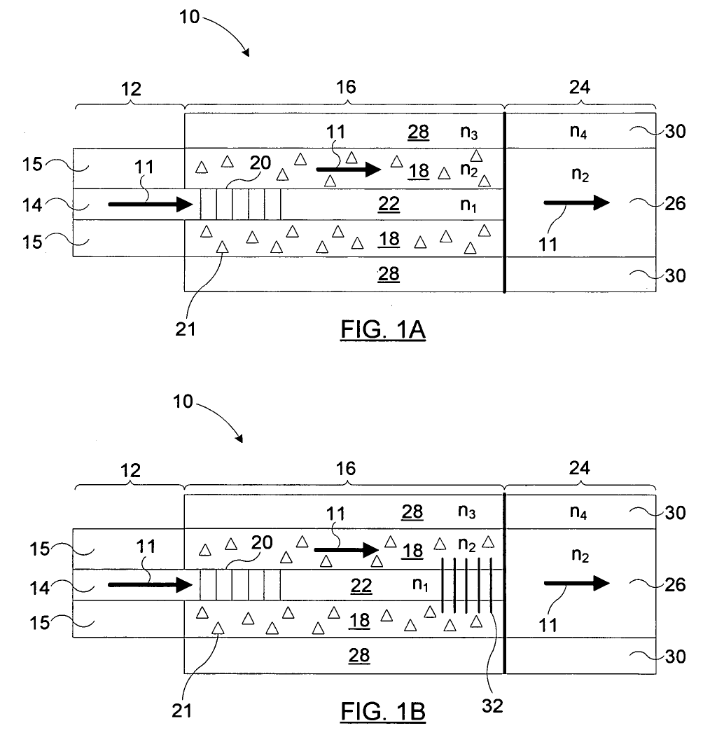

With reference to FIG. 1A, there is shown a fiber light amplifier 10 according to a first embodiment of the invention. The light amplifier 10 of FIG. 1A first includes an input optical fiber 12, having a core 14 and a cladding 15, the input fiber 12 supporting an input mode in which the input light signal 11 to be amplified propagates. In a preferred embodiment of the invention, the input fiber 12 is singlemode, in which case the input mode is by definition the single mode guided by the core 14 of the fiber 12. However, in alternative embodiments the core 14 of the input fiber 12 may be multimode, and any of the guided modes could define the input mode and therefore guide the input light signal 11. In other alternatives, the input light signal 11 may be guided in a cladding mode of the input fiber 12.

The light amplifier 10 also includes an active waveguide region 16, which is optically coupled to the input optical fiber 12 to receive the input light signal 11 therefrom. By “optically coupled”, it is understood that light can travel from the input fiber 12 to the active region without a substantial transformation of its properties and modal shape. In one embodiment, the input fiber 12 and the active waveguide region 16 share a same waveguiding core. In another embodiment, the active waveguide region 16 is embodied by a different optical fiber segment coupled to the input optical fiber 12 by fusion splicing.

The active waveguide region 16 has a core 22, which may be singlemode or multimode, a first cladding 18 surrounding the core 22 and a second cladding 28 surrounding the first cladding 18. The core 22, first cladding 18 and second cladding 28 are respectively characterized by refractive indices n₁, n₂ and n₃, selected to provide the desired waveguiding properties within the active waveguide region 16. The first cladding is rare-earth doped and pumped to define an amplification medium. In one embodiment, the dopant 21 is erbium, but other dopants such as ytterbium, praseodymium, neodymium, yttrium, thulium or any other rare-earth elements or combinations thereof could also be considered. As one skilled in the art will readily understand, to define the amplification medium a pump light beam (not shown) of an appropriate wavelength should propagate in the doped region, that is, the first cladding of the active waveguide region 16, in order to create a population inversion. Examples of common pump light beams include the 1.48 μm wavelength band or the 980 μm pumping scheme. The pump may propagate in the forward direction (away from the input fiber) or backward direction (towards the input fiber) and may be injected in the first cladding 18 in any suitable manner. The core 22 of the active waveguide region is preferably undoped, or doped with dopants other than active dopants to otherwise affect the optical properties of the active waveguide region 16, such as for example Germania, phosphorus, alumina or the liked which are commonly used in the making of optical fiber.

Throughout the present description, the term “mode” or “propagation mode” is understood to refer to the transverse intensity profile of light travelling through the various components of the amplifiers according to embodiments of the invention. The expression “cladding mode” is understood to refer to a propagation mode for which a substantial portion of the light intensity travels through the cladding of the corresponding waveguide. The active waveguide region 16 supports at least one cladding mode, that is, at least one mode substantially guided in the first cladding 18. As will be better seen further below, in one embodiment the active waveguide region may support a fundamental cladding mode and a plurality of high order cladding modes.

Still referring to FIG. 1A, the active waveguide region 16 further includes an input grating 20 provided in the core 22 of the active waveguide region 16. The input grating 20 is designed to couple the light signal to be amplifier from the input mode of the input fiber 12, to one of the cladding modes of the active waveguide region 18. In the illustrated embodiment of FIG. 1A, the input mode is the single core mode guided by the singlemode core of the input fiber 12, and the input grating 20 couples light to the fundamental cladding mode of the active waveguide region 16. The input grating may advantageously be embodied by a long period grating (LPG), a tilted grating or any equivalent thereto. Alternatively, the input grating 20 may be provided in the input fiber 12 proximate the interface with the active waveguide region 16. In another alternative, the input grating 20 may be put in an additional component provided between the input fiber 12 and the active waveguide region 16.

The light amplifier 10 also includes an output optical fiber 24 optically coupled to the active waveguide region 16, for example through fusion splicing. The output optical fiber 24 has a core 26 having waveguiding properties substantially matching those of the first cladding 18 of the active waveguiding region 16. Preferably, the core 26 of the output fiber 24 and first cladding 18 of the active waveguide region 16 have matching diameters and refractive indices. As the resulting diameter of the core 26 of the output fiber 24 can be quite large, it is preferably multimode. The core 26 of the output optical fiber 24 supports an output mode which matches the cladding mode of the active waveguide region 16 in which the light signal to be amplified is guided at the output end of the active guide region 16. In the illustrated embodiment, the output mode is the fundamental core mode of the multimode output fiber 24. The output fiber 24 further includes an outer cladding 30 surrounding the core 26. In one embodiment, the outer cladding 30 of the output fiber 24 and the second cladding 28 of the waveguiding region may correspond to a same cladding layer.

In principle, at the plane of the coupling between the active waveguide region 16 and the output fiber 24, the incident cladding mode partially transmits into the core 26 of the output fiber as well as radiation modes thereof, and can be partially reflected into a backward propagating core, cladding or radiation mode thereof. By matching the diameters and refractive indices of the first cladding 18 of the active waveguide region 16 and core 26 of the output fiber 24, backward reflection of the light signal 11 and coupling into radiative modes of the output fiber 24 will be very weak, even more so in embodiments where the refractive index n₄ of the cladding 32 of the output fiber 24 is the same as or very close to the refractive index of the second cladding 28 of the active waveguide region 16. Taking into account the boundary conditions for electromagnetic fields at the coupling plane, the following system of equations can be written:

(1+C)Eₜ^{cl}=ΣₖBₖEₜ^{co,k}, (1)

β_{cl}(1−C)Eₜ^{cl}=Σₖβ_{co}^{(k)}BₖEₜ^{co,k}, (2)

where Eₜ^{cl} and Eₜ^{co,k} are the transverse electric field of the cladding and core modes, respectively, β_{cl} and β_{co}^{(k)} are the propagation constants of the incident cladding mode and transmitted core mode for an output fiber having k core modes, and C and Bₖ are the amplitude of the reflected cladding mode and transmitted core mode, respectively. For simplicity, only the coupling of the cladding mode of the active waveguide region guiding the light signal to the core modes of the multimode output fiber have been considered. Since the core modes of the output fiber are an orthogonal set and the amplitudes of each core mode are normalized to the power of 1 W, Bₖ and C can be calculated from equations:

$$\begin{matrix}{B}_{k} = \frac{2 {n}_{cl}}{( {n}_{cl} + {n}_{co}^{k} )} {I}^{cl - co , k} & ( 3 ) \\ C = \frac{( {n}_{cl} - {n}_{co}^{k} )}{( {n}_{cl} + {n}_{co}^{k} )} , & ( 4 )\end{matrix}$$

where n_{cl}=β_{cl}/k₀, n_{co}^{k}=β_{co}^{k}/k₀ and I^{d-co,k} is the overlap integral between the cladding mode of the active waveguide region and the k-core mode of the output fiber. It can be seen that by properly choosing the waveguiding properties of the active waveguide region and output optical fiber, most of the power in the fundamental cladding mode of the active waveguide region can be transmitted into the fundamental cladding mode of the output fiber.

Referring to FIG. 1B, there is shown an alternative embodiment where the input grating 20 couples the light to be amplified to a higher order cladding mode. In order to provide proper coupling to the output fiber 24, an output grating 32 may be provided across the core 22 and first cladding 12 of the active waveguide region, proximate the output fiber 24. The output grating 32 may for example be embodied by another LPG, designed to couple the amplified light signal from the higher cladding mode it propagates into the fundamental cladding mode of the active waveguide region 16. In this manner, the amplified light can be efficiently coupled into the core of the output fiber 24.

It is one advantageous aspect of the embodiments described above that signal amplification takes place in a rare-earth doped cladding as opposed to a rare-earth doped core as usually done in the art. The diameter of the cladding (which can for example be of the order of 100 μm) in this scheme may be substantially bigger than the large core diameter in a traditional scheme of a multimode fiber used for EDFAs. This bigger cladding diameter allows a dramatic increase in the effective mode area (A_{eff}) of the signal, increasing the threshold powers for unwanted Stimulated Brillouin Scattering (SBS) and Stimulated Raman Scattering (SRS), thus to get very high output powers.

Exemplary parameter embodying light amplifiers as shown in FIGS. 1A and 1B have been simulated. It will be readily understood that these values and associated considerations and given by way of example only and are not considered limitative to the scope of the invention. In these examples, the light signal to be amplified is considered injected into the fiber core of a single mode input fiber with a diameter of 2.8 μm and refractive index of 1.47 at the wavelength λₛ=1.53 μm. This fiber is spliced to an Er³⁺ doped cladding fiber defining the active waveguide region sharing a same core with the input fiber, and the fundamental core mode is then coupled to a cladding mode by the placement of an LPG in the core. The refractive index of the first cladding in the active waveguide region is 1.444 and this cladding is uniformly doped with Er³⁺ ions with a concentration ρ≈2×10¹⁸ ions/cm³, freeing this region from any Er³⁺-Er³⁺ co-operative interaction effects. This Er³⁺ doped cladding is preferably pumped with a high power (3 kW) laser in the 1.48 μm wavelength range, which is advantageous since the 1.48 μm band has a lower, but broader, absorption cross-section and is generally used for higher power amplifiers. However, as mentioned above, other pumping schemes, such as the 980 nm, may also be used without departing from the scope of the invention.

It is well known that a properly designed LPG can convert a signal core mode into any co-propagating cladding mode with efficiency theoretically equal to 100% (R. Kashyap, Fiber Bragg Gratings, Academic Press, San Diego, 1999, pp 171-178). In a series of experimental papers published by Ramachandran and co-authors in 2006 (S. Ramachandran, M. F. Yan, J. Jasapara, P. Wisk, S. Ghalmi, E. Monberg, F. V. Dimarcello, Opt. Lett. 30, 3225 (2005); S. Ramachandran, J. M. Nicholson, S. Ghalmi, M. F. Yan, P. Wisk, E. Monberg, F. V. Dimarcello, Opt. Lett. 31, 1797 (2006); and J. M. Nicholson, S. Ramachandran, S. Ghalmi, M. F. Yan, P. Wisk, E. Monberg, F. V. Dimarcello, Opt Lett. 31, 3191 (2006)) it was shown that there is only a weak coupling between these modes. This means that the signal in the active Er³⁺ doped cladding area propagates in a single mode regime; all other fiber cladding modes are not excited.

Since the amplifier of the present example preferably uses a resonant pump scheme, it is simulated on the basis of a well developed two-level model. It is well known that only part of the optical mode that overlaps with the Er³⁺ ion dopant will experience gain or attenuation in the fiber, so the overlap integrals (┌ᵢ) between the mode field distribution and the ion doped area are relevant parameters for an amplifier design. A large area A^{Er}=π(R_{cl}²−R_{co}²)≈7786 μm² of the erbium distribution in the model used for the design of an amplifier according to the present example increases ┌ᵢ dramatically. For the present structure ┌ᵢ is the overlap between the i^{th}-cladding mode at the signal and pump wavelengths and the Er³⁺ doped fiber cladding area, A^{Er}. In this structure ┌ᵢ changes only slightly as a function of the cladding mode number; indeed, it changes by only about 0.4% for the first five odd cladding modes and by about 0.06% for the first five even cladding modes. ┌ᵢ has almost the same value for the signal and for pump wavelengths. The dispersion of ┌ᵢ in the interval of the pump bandwidth for any cladding mode is extremely small. It changes by only about 0.002% per 20 nm change in the wavelength in the vicinity of the pump and signal wavelengths. For the first cladding mode ┌₁^{s}=0.99965 for the signal and ┌₁^{p}=0.99964 for the pump. According to simulations, the optimal length of the Er³⁺ doped fiber is preferably L=15 m.

As mentioned above, the active region is preferably spliced with a specially designed output fiber with a large core, defining the output region. This large core of the multi mode fiber preferably has a diameter and refractive index equal to the diameter and refractive index of the Er³⁺ doped cladding in active region of the EDFA, respectively. This large core of the output fiber is surrounded by a cladding with the refractive index equal to the refractive index of the outer cladding surrounding the Er³⁺ doped cladding in the active region of the amplifier. This large core fiber is multimode fiber. The coupling efficiency between this cladding mode and the core modes of the output fiber can be characterised by the corresponding overlap integrals and effective refractive indices of the cladding mode and the core modes of the output fiber. The distribution of the power among the core modes of the output fiber is tightly connected with the refractive indexes and geometrical parameters if the splices fibers. In the preferred embodiment of the invention, the overlap integrals between the first cladding mode propagating in the Er³⁺ doped area and the even core modes of the output fiber are equal to almost zero. This means that the power of the cladding mode will not couple to these modes. Concerning the odd modes of the output fiber, the overlap integral between the first cladding mode and the first (fundamental) core modes of the output fiber is maximum and the difference between the refractive indices of these modes is minimum in comparison with the other core modes. The power distribution among output modes is presented in the Table 1.

TABLE 1

| Mode number | 1 | 3 | 5 | 7 | 9 | 11 | 13 |
|---|---|---|---|---|---|---|---|
| Percent of | 90.0 | 5.1 | 0.2 | 1.2 | 0.7 | 1.0 | 0.8 |
| scattered | | | | | | | |
| power (%) | | | | | | | |

Simulations results for the model explained above will now be discussed. If the amplifier is pumped with a pump power P^{p}ᵢₙ=3 kW and the input signal in the amplifier is P^{s}ᵢₙ=0.1 mW, using the first core mode a signal power P^{s}ₒᵤₜ=2.9 kW can be obtained theoretically in the plane of the splice, that is, at the end of the active region, whilst the pump power at the plane of the splice is P^{p}ₒᵤₜ≈16 W. The forward and backward traveling amplified spontaneous emission (ASE) for this device is presented in FIG. 4. The maximum of the backward traveling ASE is about 80 W. The maximum of the forward traveling ASE, which constitutes noise co-propagating with the signal, is about 10 W. It is very small in comparison with value of the signal (2.9 kW) at the plane of splice. At the plane of the splice, approximately 91% of the signal power (˜2.64 kW) will be scattered in the fundamental core mode of the output fiber with the big core. Only approximately 5% of the amplified signal power, that is about 145 W, will be scattered into the third core mode of the multimode output fiber providing undesirable noise at the output. The powers scattered in the other odd core fiber modes are very small (<35 W) in comparison with the power scattered into the fundamental fiber core mode of the multimode output fiber.

SBS is generally recognized as the dominant nonlinear effect in high-power fiber amplification, since its threshold is lower than the threshold for SRS for narrow-bandwidth signals. The widely accepted equation for the SBS threshold is

Pₜₕ^{SBS}=21A_{eff}/(L_{eff}g_{B}), (5)

where A_{eff} is the effective mode area of the propagating signal being amplified, L_{eff}=[1−exp(−αL)]/α is the effective length of the fiber, α is the fiber losses, and g_{B} is the peak Brillouin gain coefficient; g_{B} is a function of the bandwidth of the pump source (Δvₚ). From equation (5) for a fixed L_{eff}, the SBS threshold (Pₜₕ^{SBS}) will decrease with an increase in the cladding mode number since A_{eff} also decreases. If we analyze the amplified signal (taking for example the wavelength of 1.53 μm of the example above) threshold, with Δvₚ as the bandwidth of this signal, g_{B} can be described by the well-known formula:

$${g}_{B} = \frac{Δ {v}_{B}}{Δ {v}_{B} + Δ {v}_{p}} {g}_{B} ( {v}_{B} ) , \qquad ( 6 )$$

where g_{B}(v_{B}) is the peak value of the Brillouin gain coefficient occurring at v=v_{B}. In contrast to the bulk case, fiber waveguiding causes inhomogeneous broadening of the Brillouin line, which depends on the numerical aperture (NA) of the fiber.

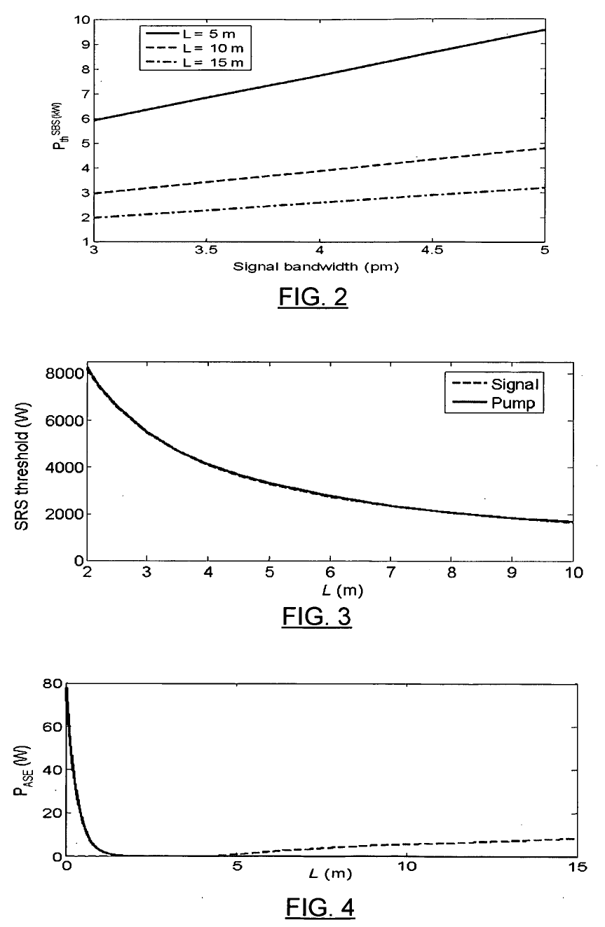

In the example above, Δv_{B}≈30 MHz. From equation (6), for a broadband pump, (˜4-5 nm) SBS is not a problem, since g_{B} is very small. For a narrowband signal (<<0.08 pm) the SBS threshold drops considerably to Pₜₕ^{SBS}≈363.56 W for L_{eff}=5 m. For broader bandwidth signals the SBS threshold increases correspondingly. This dependence is presented in FIG. 2 for three different lengths of the fiber. If the bandwidth of the signal Δλₚ=3 pm (Δvₚ=380 MHz), the SBS threshold Pₜₕ^{SBS}≈1.7 kW, 2.5 kW and 5 kW for lengths of L=15 m, 10 m and 5 m respectively. As mentioned above, the structure was simulated on the basis of a two-level model.

As mentioned above, A_{eff} influences the thresholds for SBS. Unfortunately, the A_{eff} of the mode decreases with an increase in the cladding mode number, but at the same time bend resistance also increases. For this reason, in some circumstances it may be advantageous to couple the light signal into a higher order cladding mode in the active waveguide region as in the embodiment of FIG. 1B.

Using the 7^{th} cladding mode as an example, if the amplifier is pumped with a pump power P^{p}ᵢₙ=3 kW and the input signal has a power P^{s}ᵢₙ=0.1 mW, an amplified signal power P^{s}ₒᵤₜ=2.7 kW can be achieved in the plane of the splice at the end of the active waveguide region with the length L_{eff}=15 m, and the remnant pump power in the plane of the splice P^{p}ₒᵤₜ≈17 W. Approximately 90% of the signal power (˜2.4 kW) will be scattered into the fundamental core mode of the output fiber. As we can see from these simulations, using a higher order cladding mode (for example 7th) instead of the first cladding mode with the aim of increasing bend resistance, output powers comparable with the first cladding mode can be obtained, but the reduction in A_{eff} for higher order modes has to be compensated for by the slight (a few lm) increase in the diameter of the cladding in order to be free from nonlinear effects.

The second important process that limits the amplified signal in the fiber amplifiers is SRS. Its threshold is higher than the threshold of the SBS and can be estimated using the formula:

pₜₕ^{SRS}=16A_{eff}/(L_{eff}g_{R}), (7)

where g_{R} is the peak Raman gain coefficient. As with SBS, backward SRS is permitted in the fiber geometry as well, but since its threshold is higher than the threshold for forward SRS, it is generally not observed in optical fibers and will not be considered. If polarization is not preserved, the Raman threshold will increase by a factor of between 1 and 2 with a maximum value of 2 if the polarization is completely scrambled.

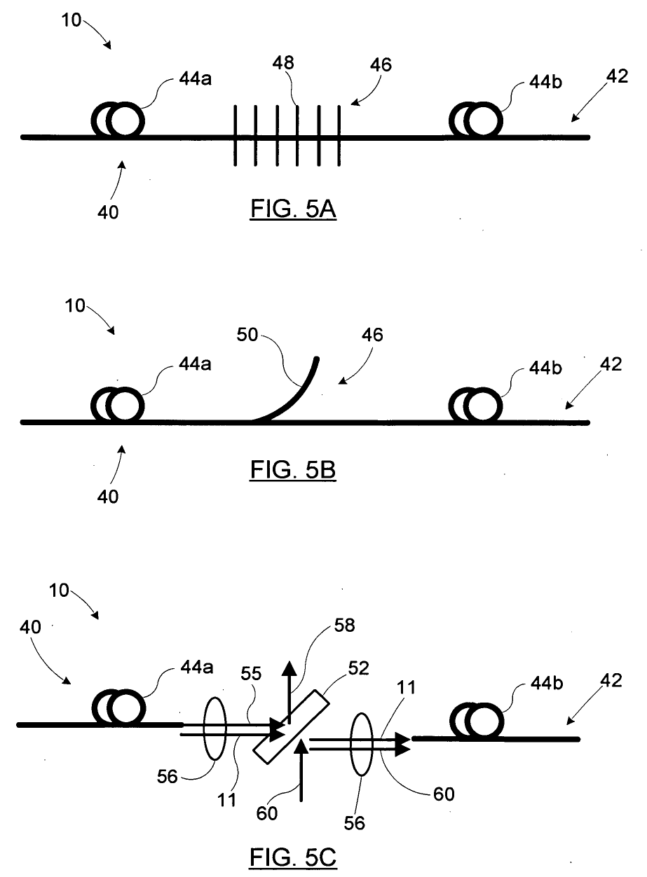

As can be seen from equation (7), the onset of SRS can be avoided by a proper control of the parameters A_{eff} and L_{eff}. However, setting these parameters to appropriate values for reducing the SRS threshold may unduly reduce the maximum amplification achievable by the amplifier. Referring to FIGS. 5A to 5C, there are shown light amplifiers 10 according to alternative embodiments, where a scheme of particular interest is provided to mitigate the effects of SRS.

The light amplifier 10 according to these embodiments includes a first and a second amplifications stages 40 and 42 which each amplifying the input light signal propagating successively therethrough. Each amplification stage 40, 42 includes an optical fiber segment 44a, 44b supporting a signal guiding mode for guiding the input light signal. The optical fiber segment 44a, 44b of each amplification stage 40, 42 is doped and pumped to define an amplification medium.

In these embodiments, the amplification medium may be provided in the core of the corresponding optical fiber segment 44a, 44b, its cladding or both. The signal guiding mode may therefore be embodied by a core mode or a cladding mode, and may be a high order mode propagating in either region. The dopants may be any appropriate rare-earth element as discussed above. The first amplification stage 40 may receive the input signal in any appropriate manner, such as, but not limited to, optical coupling to an input fiber as described above.

As also explained above, the optical fiber segment will generate a Stokes wave, co-propagating with the input light signal in the signal guiding mode, through Raman scattering of the input light signal. SRS essentially occurs as a process which starts from the noise created by the co-propagating Stokes wave. A noise photon is amplified by the “pump” of the stimulated process (here the input light signal, not the “pump” used to create a population inversion in the amplification media) as it co-propagates along a length of fibre until it reaches a level at which it is close to the pump power or some significant fraction thereof. This process continues as the first Stokes photons amplify noise photons in the second Stokes wavelength.

The stimulated process can be described by the following set of equations:

$$\begin{matrix}\frac{d {l}_{g}}{d z} = {g}_{R} {I}_{p} {I}_{s} - {α}_{s} {I}_{s} , & ( 8 ) \\ \frac{d {l}_{p}}{d s} = \frac{{λ}_{z}}{{λ }_{p}} {g}_{R} {I}_{p} {I}_{z} - {α}_{p} {I}_{p} + {g}_{p} {I}_{p} . & ( 9 )\end{matrix}$$

where z is the distance along the corresponding fiber segment, gₚ is the gain of the amplified signal, which acts as the pump for the Stokes wave, lₚ and lₛ respectively represent the intensity of the input light signal and the Stokes wave, λ_{p,s} is the wavelength of the corresponding signal and α_{p,s} is the associated linear attenuation coefficient. One skilled in the art will understand that these equations simply consider the SRS process and not the amplifier process simultaneously, in order to provide an understanding of the principle of operation of this embodiment of the invention.

If the amplified Stokes field was to be reduced to approximately zero at some point along the optical fiber segment 44 of the first amplification stage 40, then equation (9) becomes:

$$\frac{d {l}_{p}}{d z} \approx - {α}_{p} {I}_{p} + {g}_{p} {I}_{p} . \qquad ( 10 )$$

which implies that there is no onset of the stimulated effect. In this approximation, the Stokes field is simply reduced to the initial noise level as it was at the input of the optical fiber segment. It has been found through simulations that the losses for the Stokes wave need not be very large, nor continuous as in specially designed fibers (SAHU et al (PHOTONICS-2008: International Conference on Fiber Optics and Photonics, Dec. 13-17, 2008, IIT Delhi, India.)), but simply a point-loss element placed judiciously along the amplifier 10. The inventors found that in one example a simple loss of 3 dB was sufficient when positioned well before the SRS process really kicks off.

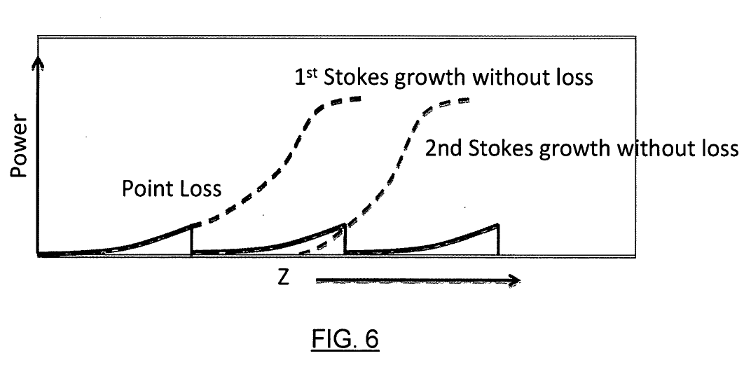

The principle above is best illustrated with reference to FIG. 6. As can be seen, by resetting the power in the Stokes wave to a lower value through a suitably placed point loss, the SRS growth is avoided. This scheme may be repeated any number if times, providing for amplification over a greatly increased length.

Referring to FIG. 5A to 5C, the light amplifier 10 of this embodiment of the invention therefore includes a wavelength selective loss element 46 provided between the first and second amplification stages 40 and 42, for selectively coupling the Stokes wave generated in the optical fiber segment 44a of the first amplification stage 40 out of the signal guiding mode. The properties and length of the optical fiber segment 44a of the first amplification stage are preferably selected so that the Stokes wave propagating therealong does not travel a distance sufficient for its power to reach the SRS threshold. By coupling at least a portion of the Stokes wave out of the amplifier, the noise level in the input light signal is reset, and the input light signal is coupled to the second amplification stage 42 where it continues to be amplified without the onset of SRS being reached. Preferably, the properties and length of the optical fiber segment 44b of the second amplification stage 42 are also selected so that the new Stokes wave generated and propagating therealong does not travel a distance sufficient for its power to reach the SRS threshold. If the intensity of the input light signal at the output of the second amplification stage is still not sufficient for the targeted application, then one or more additional amplification stages may be added at the end of the second one 42, each coupled to the preceding amplification stage through a corresponding wavelength selective loss element.

It is to be noted that in some embodiments where the first Stokes wave serves a useful purpose, the same principle may be used to couple the second Stokes wave or any higher order out of the signal propagating mode through a proper selection of the spectral characteristics of the wavelength selective loss element.

Referring to FIG. 5A, in on embodiment the optical fiber segments 44a and 44b of the first and second amplification stages are integral to a same optical fiber, and the wavelength selective element 46 includes a long period grating 48 provided therein, coupling the Stokes wave to a different mode than the signal guiding mode, such as for example a higher order mode, a cladding mode or a radiative mode. In the embodiment of FIG. 5B, the wavelength selective loss element 46 includes a fiber coupler 50, such as for example a fused coupler. One skilled in the art will readily understand that either the LPG 48 or fiber coupler 50 may be designed to couple light at the Stokes wavelength out of the optical fiber, while leaving light at the input signal wavelength to propagate therealong. In some embodiments the fibre coupler 50 could also be used as a wavelength selective pump coupler as explained below with reference to FIG. 5C.

Referring to FIG. 5C there is shown another example where the wavelength selective loss element 46 includes a reflective element 52 external to the optical fiber segments 44a and 44b of the first and second amplification stages 40 and 42. The reflective element 52 may for example be embodied by a thin film dichroic filter, which reflects light at the Stokes wavelength 58 out of the system but allows the input signal 11 through. Appropriate optical components such as lenses 56 may be provide along with any appropriate scheme to hold and align the fiber in order to provide a proper coupling between the reflective element 52 and amplifications stages 40 and 42, as will be readily understood by one skilled in the art. If required, the reflective element 52 may advantageously also be used to couple pump power 60 in the second amplification stage 42 to create the population inversion therein.

In one example, the design of FIG. 5A was simulated using an optical fiber segment 44a in the first amplification stage 40 of a length of 12 m and an output amplified power of around 2.7 kW as the SRS threshold. If this power was maintained for another 12 m, then the 1st Stokes power would equal the depleted amplified power (˜2.7/2 kW). However, when placing a 3 dB loss element at the 1st Stokes wavelength at 12 m, then the threshold is not reached, and further amplification of the amplified mode can continue without disruption, leading to even higher powers.

In variants to the above embodiments, by placing one more loss elements periodically at specific points, the reach of an optical fiber may be increased for sensing using Raman scattering.

For example, Distributed Temperature Sensors (DTS) use the analysis of the Raman Stokes lines to assess the temperature distribution along an optical fiber. In a pulsed Raman sensing system, the returned spontaneous or stimulated Raman light may be used for sensing strain or temperature. The ratio of the Stokes and the Anti-Stokes intensity can provide a direct measurement of the local temperature or strain, using standard equations for Raman scattering. The time-dependence of the signal can be studied using Optical Time Domain Reflectometry (OTDR).

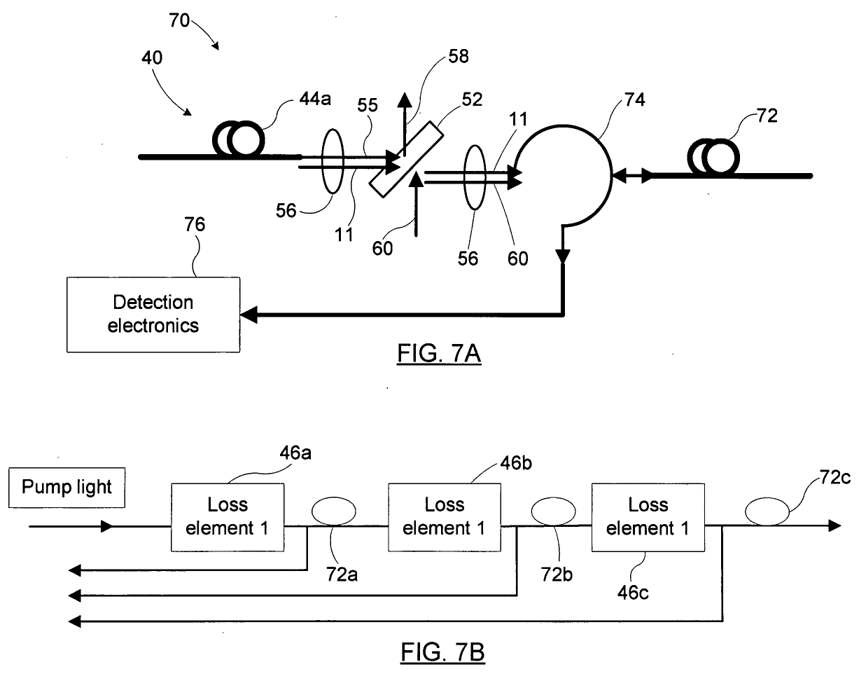

FIG. 7A shows an optical sensor 70 where the reach of a sensing fiber may be extended by the use of a loss element, instead of special coding, whilst maintaining high temperature and spatial resolution. The illustrated embodiment is similar to that of FIG. 5C, where an initial amplification stage 40 is provided to amplify the pulsed light signal propagating therein to desired power levels. A loss element, such as a reflective thin film dichroic filter 52 or the like, couples the Stokes wave out of the amplified pulsed signal an allows this signal through to a sensing fiber 72. The next section then becomes available for sensing. A circulator 74 is provided between the loss reflective element 52 and the sensing fiber, to collect the light circulated back from the sensing fiber 72 and forward it to detection electronics 76 for analysis.

Referring to FIG. 7B to increase the reach of Raman sensors to tens of km, such as for example required for sensing in the oil and gas industry, several in-line loss elements 52a, 52b, 52c may be placed every few km for example can make the last section available for sensing using spontaneous Raman scattering. The principle may be applied to standard single mode optical fibers, making the scheme extremely simple. Higher peak powers may be used with shorter pulses to increase resolution in temperature and also spatially. If the loss elements 52a, 52b, 52c have the capability of being switched at will, then any section 72a, 72b, 72c in the link may become available for sensing in a sequential manner. It should be noted that the loss element may also be used to eliminate any four wave mixing generated frequencies periodically.

Of course, numerous modification could be made to the embodiments described above without departing from the scope of the invention as defined in the appended claims.

1. A light amplifier, comprising:
an input optical fiber supporting an input mode;
an active waveguide region optically coupled to the input optical fiber and having a core and a first cladding, the first cladding being rare-earth doped and pumped to define an amplification medium, the active waveguide region supporting at least one cladding mode;
an input grating provided for coupling light from the input mode to one of the at least one cladding mode of the active waveguide region; and
an output optical fiber optically coupled to the active waveguide region, the output optical fiber comprising a core having waveguiding properties substantially matching waveguiding properties of the first cladding of the active waveguide region.

2. The light amplifier according to claim 1, wherein the input optical fiber has a core, the input mode being guided in said core.

3. The light amplifier according to claim 2, wherein the core of input optical fiber is singlemode.

4. The light amplifier according to claim 2, wherein the core of the input fiber and the core of the active waveguide region are provided in a same optical fiber.

5. The light amplifier according to claim 1, wherein the core of the active waveguide region is singlemode.

6. The light amplifier according to claim 1, wherein the core of the active waveguide region is undoped.

7. The light amplifier according to claim 1, wherein the input grating is a long period grating.

8. The light amplifier according to claim 1, wherein the input grating is located in the core of the active waveguide region.

9. The light amplifier according to claim 1, wherein the active waveguide region further comprises a second cladding surrounding the first cladding.

10. The light amplifier according to claim 1, wherein the one of the at least one cladding mode in the first cladding of the active waveguide region is a fundamental cladding mode.

11. The light amplifier according to claim 1, wherein the one of the at least one cladding mode in the first cladding of the active waveguide region is a high-order cladding mode.

12. The light amplifier according to claim 11, further comprising an output grating provided across the core and first cladding of the active waveguide region for coupling light from the high-order cladding mode to a fundamental cladding mode of the active waveguide region.

13. The light amplifier according to claim 1, wherein the active waveguide region and the output fiber are optically coupled through fusion splicing.

14. The light amplifier according to claim 1, wherein the core of the output fiber is multimode.

15. The light amplifier according to claim 14, wherein the output mode is a fundamental core mode of the output optical fiber.

16. The light amplifier according to claim 1, wherein the matching waveguiding properties of the core of the output fiber and the first cladding of the active waveguide region comprise substantially identical diameters thereof.

17. The light amplifier according to claim 16, wherein the matching waveguiding properties of the core of the output fiber and the first cladding of the active waveguide region comprise substantially identical refractive indices thereof.

18. A light amplifier for amplifying an input light signal, comprising:
first and second amplification stages successively amplifying said input light signal, each amplification stage comprising an optical fiber segment supporting a signal guiding mode for guiding said input light signal, said optical fiber segment being doped and pumped to define an amplification medium amplifying said input light signal, said optical fiber segment generating a Stokes wave through Raman scattering of the input light signal, the Stokes wave co-propagating with said input light signal in the signal guiding mode;
a wavelength selective loss element provided between the first and second amplification stages for selectively coupling the Stokes wave generated in the optical fiber segment of the first amplification stage out of the signal guiding mode.

19. The light amplifier according to claim 18, wherein the optical fiber segments of the first and second amplification stages are integral to a same optical fiber.

20. The light amplifier according to claim 19, wherein the wavelength selective element comprises a long period grating provided in said optical fiber.

21. The light amplifier according to claim 18, wherein the wavelength selective loss element comprises a fiber coupler.

22. The light amplifier according to claim 18, wherein the wavelength selective loss element comprises a reflective element external to the optical fiber segments of the first and second amplification stages.

23. The light amplifier according to claim 22, wherein the reflective element comprises a thin film dichroic filter.

24. The light amplifier according to claim 18, wherein the signal guiding mode is a core mode.

25. The light amplifier according to claim 18, wherein the signal guiding mode is a cladding mode.

26. The light amplifier according to claim 18, wherein the wavelength selective loss element couples the Stokes wave to a radiative mode.

27. The light amplifier according to claim 18, wherein the wavelength selective loss element couples the Stokes wave to a cladding mode.
